(19) United States
(12) Patent Application Publication
(10) Pub. No.: US 2021/0136182 A1
(43) Pub. Date: May 6, 2021

(54) VEHICLE CONTROLLER, SYSTEM INCLUDING THE SAME, AND METHOD THEREOF

(71) Applicants: HYUNDAI MOTOR COMPANY, SEOUL (KR); KIA MOTORS CORPORATION, SEOUL (KR)

(72) Inventor: Ho Jin JUNG, Bucheon-si (KR)

(73) Assignees: HYUNDAI MOTOR COMPANY, SEOUL (KR); KIA MOTORS CORPORATION, SEOUL (KR)

(21) Appl. No.: 17/069,488

(22) Filed: Oct. 13, 2020

(30) Foreign Application Priority Data
Nov. 6, 2019 (KR) 10-2019-0141275

(51) Int. Cl. H04L 29/06

(52) U.S. Cl. CPC H04L 69/03; H04L 12/40

(57) ABSTRACT

A vehicle controller, a system including the same, and a method thereof are provided. The vehicle controller includes a communication device that receives a diagnostic message for diagnosing of a vehicle from an external diagnostic device and a processor that identifies the diagnostic message and controls the communication device to transmit data generated in the vehicle under a transport protocol (TP) selected between a first TP configuring data to a predetermined size and a second TP configuring data to a variable size, the second TP being distinguished from the first TP.

### CROSS-REFERENCE TO RELATED APPLICATION

The present application claims the priority to and the benefit of Korean Patent Application No. 10-2019-0141275, filed on Nov. 6, 2019, the entire contents of which are incorporated herein by reference.

### TECHNICAL FIELD

The present disclosure relates to a vehicle controller, a system including the same, and a method thereof, and more particularly, relates to technologies of duplexing a data transport protocol for vehicle control.

### BACKGROUND

The statements in this section merely provide background information related to the present disclosure and may not constitute prior art.

With the development of electronic devices of the vehicle, as there has an increase in the amount of communication data due to an increase in the number of controllers applied in the vehicle and an increase in mutual collaboration control, controller area network (CAN) bus loads have steadily increasing. Thus, there is a need for a protocol for transmitting quicker and more data. The controller area network with flexible data rate (CAN-FD) is a protocol for resolving such a problem, which reuses existing physical communication without change, increases a communication speed of a data portion from 500 Kbps to 2 Mbps and increases the amount of data from 8 bytes to 64 bytes.

However, because both of diagnostic communication rules of North America and external diagnostic infrastructure use a classical CAN (500 Kbps), compatibility with the vehicle may not be maintained. With regard to such communication rules and data transfer environments, there is a need for an efficient vehicle communication method for maintaining compatibility with external diagnostic equipment while satisfying the standard specification.

### SUMMARY

An aspect of the present disclosure provides a vehicle controller for duplexing a transmission/reception protocol in a vehicle control system, a system including the same, and a method thereof.

Another aspect of the present disclosure provides a vehicle controller for duplexing a protocol for data transfer with regard to a transport protocol of a transmitter in vehicle control system, a system including the same, and a method thereof.

Another aspect of the present disclosure provides a vehicle controller for configuring a data transport protocol of a different size in a vehicle control system, a system including the same, and a method thereof.

Another aspect of the present disclosure provides a vehicle controller for selectively controlling a protocol with regard to a varied data size in a vehicle control system, a system including the same, and a method thereof.

Another aspect of the present disclosure provides a vehicle controller for selecting a different CAN protocol with regard to whether to pass through a gateway in vehicle control system, a system including the same, and a method thereof.

Another aspect of the present disclosure provides a vehicle controller for doubly establishing a CAN protocol with regard to a data transfer format of an external diagnostic device in a vehicle control system, a system including the same, and a method thereof.

Another aspect of the present disclosure provides a vehicle controller for adaptively establishing a protocol for a standard diagnosis specification in a vehicle control system, a system including the same, and a method thereof.

The technical problems to be solved by the inventive concept are not limited to the aforementioned problems, and any other technical problems not mentioned herein will be clearly understood from the following description by those skilled in the art to which the present disclosure pertains.

According to an aspect of the present disclosure, a vehicle controller may include a communication device that receives a diagnostic message for diagnosis in a vehicle from an external diagnostic device and a processor that identifies the diagnostic message received via the communication device and controls the communication device to transmit data generated in the vehicle under a transport protocol (TP) selected between a first TP configuring data to a fixed size and a second TP configuring data to a variable size, the second TP being distinguished from the first TP.

In an embodiment, the processor may include a first controller configured to control the first TP to transmit data with an 8-byte size and a second controller configured to control the second TP to transmit data with a byte size greater than the 8-byte size.

In an embodiment, the processor may configure the first TP and the second TP in a duplex mode and may configure and transmit the data generated in the vehicle into a frame of an adaptive size depending on the diagnostic message.

In an embodiment, the processor may set a data length code (DLC) for the first TP to 8 bytes.

In an embodiment, the processor may compare the DLC set to 8 bytes with the data generated in the vehicle and may configure a controller area network (CAN) TP data frame of an 8-byte size.

In an embodiment, the processor may set a DLC for the second TP to 64 bytes.

In an embodiment, the processor may compare the DLC set to 64 bytes with the data generated in the vehicle and may configure a controller area network with flexible data rate (CAN-FD) TP data frame of an 64-byte size.

In an embodiment, the processor may set a DLC for the second TP to at least one of 8, 12, 16, 20, 24, 32, or 48 bytes.

In an embodiment, the processor may compare the DLC set to 8 bytes with the data generated in the vehicle to configure a single frame and may compare the DLC set to 8 bytes with a predetermined minimum value to configure a first frame.

In an embodiment, the processor may set the predetermined minimum value to 63.

According to another aspect of the present disclosure, a vehicle control method may include receiving a diagnostic message for diagnosis in a vehicle from an external diagnostic device and identifying the received diagnostic message and controlling to transmit data generated in the vehicle under a transport protocol (TP) selected between a first TP configuring data to a fixed size and a second TP configuring data to a variable size, the second TP being distinguished from the first TP.

In an embodiment, the controlling may include controlling the first TP to transmit data with an 8-byte size and controlling the second TP to transmit data with a byte size greater than the 8-byte size.

In an embodiment, the controlling may include configuring the first TP and the second TP in a duplex mode and controlling to configure and transmit the data generated in the vehicle into a frame of an adaptive size depending on the diagnostic message.

In an embodiment, the controlling may include setting a data length code (DLC) for the first TP to 8 bytes.

In an embodiment, the controlling may include comparing a DLC set to 8 bytes with the data generated in the vehicle and configuring a CAN TP data frame of an 8-byte size.

In an embodiment, the controlling may include setting a DLC for the second TP to 64 bytes.

In an embodiment, the controlling may include comparing the DLC set to 64 bytes with the data generated in the vehicle and configuring a CAN-FD TP data frame of a 64-byte size.

In an embodiment, the controlling may further include setting a DLC for the second TP to at least one of 8, 12, 16, 20, 24, 32, or 48 bytes.

In an embodiment, the controlling may include comparing a DLC set to 8 bytes with the data generated in the vehicle to configure a single frame and comparing the DLC set to 8 bytes with a predetermined minimum value to configure a first frame.

In an embodiment, the controlling may include setting the predetermined minimum value to 63.

### DRAWINGS

In order that the disclosure may be well understood, there will now be described various forms thereof, given by way of example, reference being made to the accompanying drawings, in which:

FIG. 1 is a block diagram illustrating a configuration of a vehicle system including a vehicle controller in one form of the present disclosure;

FIG. 2 is a block diagram schematically illustrating a CAN communication mode in one form of the present disclosure;

FIG. 3 is a drawing illustrating a CAN data frame structure in one form of the present disclosure;

FIG. 4 is a drawing illustrating a CAN-FD data frame structure in one form of the present disclosure;

FIG. 5 is a drawing illustrating a structure of a CAN transport protocol (TP) in one form of the present disclosure;

FIG. 6 is a flowchart illustrating CAN protocol duplexing in one form of the present disclosure; and

FIG. 7 is a block diagram illustrating a computing system in one form of the present disclosure.

The drawings described herein are for illustration purposes only and are not intended to limit the scope of the present disclosure in any way.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

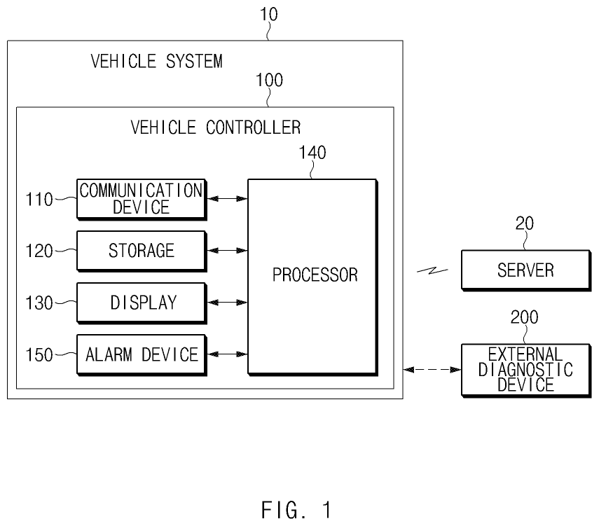

Hereinafter, embodiments of the present disclosure will be described in detail with reference to FIGS. 1 to 7.

FIG. 1 is a block diagram illustrating a configuration of a vehicle system including a vehicle controller according to an embodiment of the present disclosure.

Referring to FIG. 1, a vehicle controller 100 according to an embodiment of the present disclosure may include a communication device 110, a storage 120, a display 130, a processor 140, and an alarm device 150.

The communication device 110 may be a hardware device implemented with various electronic circuits to transmit and receive a signal through a wireless or wired connection. In an embodiment of the present disclosure, the communication device 110 may perform inter-vehicle communication through controller area network (CAN) communication, control area network flexible data rate (CAN FD) communication, local interconnect network (LIN) communication, Ethernet communication, or the like. The communication device 110 may include various communication units, for example, a mobile communication unit, a broadcast receiving unit, such as a digital multimedia broadcasting (DMB) module or a digital video broadcasting-handheld (DVB-H) module, a short-range communication unit, such as a ZigBee module or a near field communication (NFC) module which is a Bluetooth module, and a wireless-fidelity (Wi-Fi) unit to communicate with a server 20 outside a host vehicle, an external diagnostic device 200, and the like.

The storage 120 may store data downloaded for vehicle wireless update, which is received from a server 20 via the communication device 110. Furthermore, the storage 120 may store at least one of a network load, a vehicle power state, a battery state, or a time expected to transmit remaining ROM data, which is determined by the processor 140. The storage 120 may include at least one type of storage medium, such as a flash memory type memory, a hard disk type memory, a micro type memory, a card type memory (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic RAM (MRAM), a magnetic disk, and an optical disk.

The display 130 may be controlled by the processor 140 to display a screen for being granted user authentication for wireless update of the host vehicle. The display 130 may be implemented as a head-up display (HUD), a cluster, an audio video navigation (AVN), or the like. Furthermore, the display 130 may include at least one of a liquid crystal display (LCD), a thin film transistor-LCD (TFT-LCD), a light emitting diode (LED) display, an organic LED (OLED) display, an active matrix OLED (AMOLED) display, a flexible display, a bended display, or a three-dimensional (3D) display. Some thereof may be implemented as transparent displays configured as a transparent type or a semi-transparent type to see the outside. Moreover, the display 130 may be implemented as a touchscreen including a touch panel to be used as an input device other than an output device.

The processor 140 may be electrically connected with the communication device 110, the storage 120, the display 130, the alarm device 150, or the like and may electrically control the respective components. The processor 140 may be an electrical circuit which executes instructions of software and may perform a variety of data processing and calculation described below.

Particularly, according to an example of the present disclosure, the processor 140 may identify a message of an external diagnostic device 200 and may configure data generated in the host vehicle in the form of a standardized message or in the form of a message for improved data transfer under a transport protocol (TP) of the message to transmit and receive the configured data. In this case, the processor 140 may establish a controller area network (CAN) TP of a standardized 8-byte format and a controller area network with flexible data rate (CAN-FD) TP of an improved data format in a duplex structure, may identify a diagnostic message transmitted from an external controller to distinguish a CAN/CAN-FD TP, and may control to configure and transmit a CAN message to suit an external diagnosis situation and a standard specification. As a result, the processor 140 may control to select a CAN protocol for satisfying diagnostic rules of North America and maintain compatibility with the legacy external diagnostic device 200. Furthermore, when using a frequent reprogram in the development stage as a temporary connector, the processor 140 may control to select a CAN-FD protocol and transmit data at the CAN-FD speed and by the data amount of 64 bytes.

The external diagnostic device 200 may be a device for diagnosing a plurality of ECUs and systems in the host vehicle in the host vehicle or in the outside and may identify diagnosis data in the entire system or the host vehicle through several usecase windows as well as a separate ECU. The external diagnostic device 200 may directly access the host vehicle or may be used for remote diagnosis of the host vehicle in a remote distance (wirelessly), depending on user's needs. According to an example of the present disclosure, the external diagnostic device 200 may diagnose vehicle test driving, vehicles in an overseas production plant, customer's vehicles of a service center, or the like. The display 130 may graphically and separately display whether a fault memory occurs for each ECU with respect to all ECUs depending on the specifications and performance of the external diagnostic device 200, may display the identified diagnostic trouble code (DTC) together with a status flag, environmental data, and an error condition, and may collect general information about the installed ECU. Particularly, the display 130 may measure diagnostic data and a CAN signal according to an example of the present disclosure and may graphically display the measured value.

When a screen for being granted from the user is displayed on the display 130, the alarm device 150 may output a notification for approval to the user.

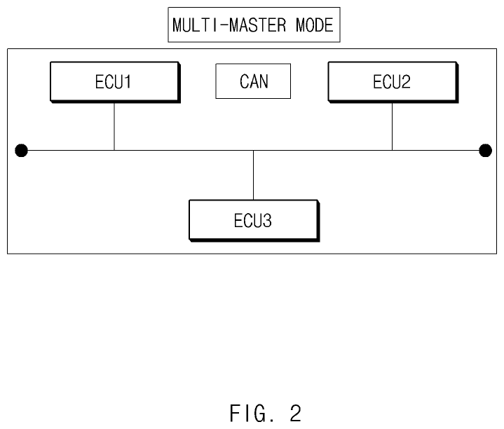

FIG. 2 is a block diagram illustrating a CAN communication system according to an embodiment of the present disclosure.

Referring to FIG. 2, the CAN is the standard communication specification designed such that micro-controllers or devices communicate with each other without a host computer in the vehicle. A plurality of electronic control units (ECUs) in the vehicle may communicate using a CAN protocol. The CAN protocol was initially developed for vehicle network. However, recently, the CAN protocol has been widely applied to the whole industrial field as well as vehicles. Seeing features of the CAN applied to an embodiment of the present disclosure, there are the following advantages.

Several ECUs may be connected to one CAN bus, and a plurality of ECUs may transmit and receive a message through the CAN bus. CAN communication may use a manner which allocates an identifier (ID) depending on a priority of a message rather than exchanging data depending on an address of each node and distinguishes the message using the ID. In other words, when any ECU 1 transmits a message, ECU 2 and ECU 3, which are the other nodes except for ECU 1, may determine whether the message transmitted by ECU 1 is a message they need, based on the ID. ECU 2 and ECU 3 may perform communication in the form of receiving the message when the message transmitted by ECU 1 is the message they need, based on the ID, and ignoring the message when the message transmitted by ECU 1 is not the message they need.

When the CAN bus is empty because all ECUs are masters in a corresponding network based on the CAN, that is, when the CAN bus is an idle state, it is possible to transmit a message at any time. In this case, as it is possible for the CAN to transmit a message depending on a priority (an ID), messages may not be transmitted at the same time. In other words, after a message with a high priority is first transmitted, a message with a low priority may then be transmitted. Thus, the CAN communication may provide a stable network (a multi-communication mode or a multi-master mode) where several CAN devices may communicate with each other. As a plurality of ECUs have only a single CAN interface, the CAN communication may reduce the cost and weight of the entire system although considering ECUs in the vehicle, which are increasing more and more.

The ECU applied to an embodiment of the present disclosure may include a large number of electronic controllers used in the vehicle and may include an airbag control unit (ACU), an engine control unit (ECU), a transmission control unit (TCU), a brake control unit (BCU), On-Board-Diagnostics (OBD), or the like. The ECU may include various electronic controllers emerging according to a service of an autonomous vehicle based on a recent 5G service and service demands of the user.

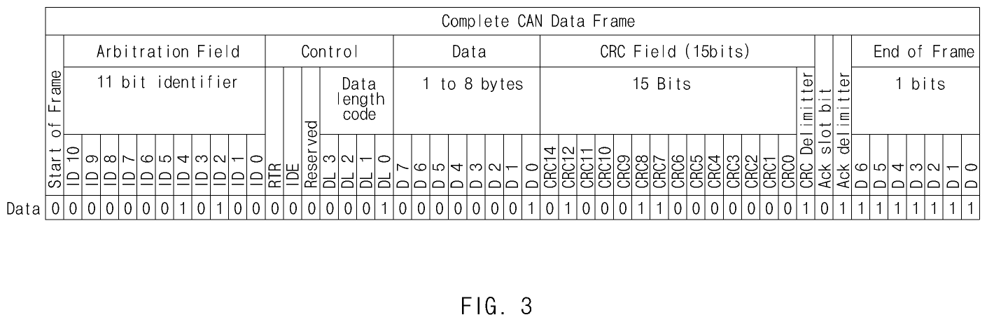

FIG. 3 is a drawing illustrating a CAN message format structure according to an embodiment of the present disclosure.

Referring to FIG. 3, 4 frame types of a data frame, a remote frame, an error frame, and an overload frames may be defined in the CAN.

The data frame may be generally used for data transfer, and the remote frame may be used when a receive node requests a transmit node capable of transmitting a desired message to transmit the message. The error frame may be used for the purpose of notifying a system that an error of the message is detected, and the overload frame may be used for the purpose of synchronization of the message. Data transmission and reception in CAN communication may be performed using a message frame.

Each field of a CAN data frame applied to an embodiment of the present disclosure will be described in brief.

The start of frame (SOF) may consist of one dominant bit and may be used to indicate the beginning of a message and for synchronization of all nodes.

The arbitration field may consist of an 11- (standard) or 29-bit (extended) ID and a 1-bit remote transmission request (RTR) bit. This region may be used to adjust collision between messages, which occurs when the messages are transmitted from two or more nodes at the same time. The value of the RTR bit may be used to determine whether a current frame is a data frame (‘d’) or a remote frame (‘r’).

The control field may consist of a 2-bit identifier extension (IDE) bit and a 4-bit data length code (DLC). R0 is a reserved bit (extended CAN 2.0B R0, R1).

The data field is available up to 8 bytes, may be used to store data, and may include data transmitted from a specific node to another node.

The cyclic redundancy check (CRC) field may consist of a 15-bit CRC sequence generated using a bitstream from the SOF to the data field and a CRC parameter of one ‘r’ bit. This may be used to check there is an error on the message.

The acknowledge (ACK) field may consist of an 1-bit ACK slot and one ACK parameter (‘d’). When receiving a correct message, any node may set a value of the ACK slot to ‘d’ at the moment of receiving the ACK field to continue transmitting the message on the bus.

The end of frame (EOF) field may consist of 7 ‘r’ bits and may be used for the purpose of marking the end of the message.

As described above, the frame structure of the CAN data may be used to basically transmit data up to a maximum of 8 bytes.

Meanwhile, data traffic may be more increased because the plurality of ECUs are increased in the vehicle. Thus, a CAN-FD is proposed as a new communication method to resolve a high lose applied to the CAN bus. A CAN-FD protocol may process more data and may support a data transfer rate by expanding a data length of the CAN protocol from 8 bytes to 64 bytes. In this case, the CAN-FD protocol may support the CAN protocol despite a data length expanded due to an increase in CRC field.

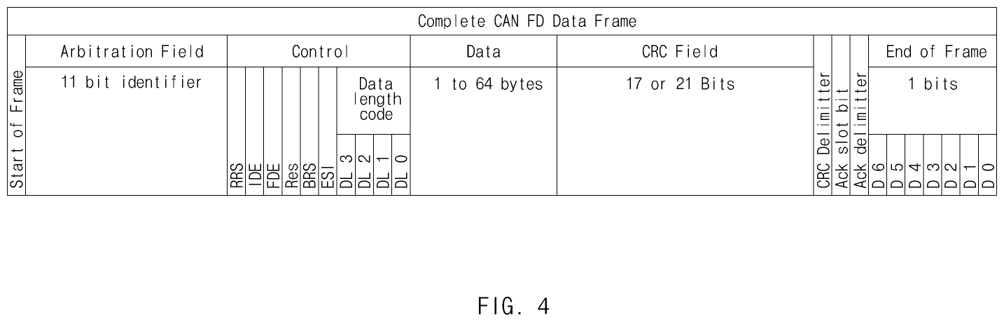

FIG. 4 is a drawing illustrating a CAN-FD message format structure according to an embodiment of the present disclosure.

Referring to FIG. 4, in a CAN-FD, new 3 bits such as a frame data format (FDF) bit, a bit rate switch (BRS) bit, and an error state indicator (ESI) bit may be included in a control field. The FDF bit may distinguish a frame of a CAN-FD format from a frame of an existing format. When the FDF bit is recessive (1), the current frame may be defined as a CAN-FD frame. When the FDF bit is dominant (0), the current frame may be defined as a CAN frame. When the BRS bit is recessive (1), a current bit rate is changed to a quicker bit rate when transmitting a data field. The ESI bit may be used to identify an error of a CAN-FD node. Furthermore, a data length code (DLC) may consist of 4 bits and may define the length of data every 8, 12, 16, 20, 24, 32, 48, and 64 bytes. Table 1 below describes the DLC supportable in the CAN-FD.

TABLE 1

| Data Length Code | Number of data bytes |
|---|---|
| (DLC) | (CAN_DL) |

| | | | | |
|---|---|---|---|---|
| 1 | 0 | 0 | 0 | 8 |
| 1 | 0 | 0 | 1 | 12 |
| 1 | 0 | 1 | 0 | 16 |
| 1 | 0 | 1 | 1 | 20 |
| 1 | 1 | 0 | 0 | 24 |
| 1 | 1 | 0 | 1 | 32 |
| 1 | 1 | 1 | 0 | 48 |
| 1 | 1 | 1 | 1 | 64 |

As described above, the CAN-FD frame is to increase a bit rate of a control field portion and a data field portion using the FDF bit and BRS bit and support transmission of more data in the same time. In other words, the control field may be expanded from 6 bits to 9 bits, and the data field may be expanded from 8 bytes to 64 bytes. The bits added to the control field may be to adaptively select control information corresponding to the length of the data field through the FDF, the BRS, and the ESI.

In detail, the CAN-FD frame uses a CAN TP to transmit larger amounts of data, and a structure thereof is shown in Table 2 below.

TABLE 2

| | N_PCI bytes | | | | | | | | | |
|---|---|---|---|---|---|---|---|---|---|---|
| | Byte 1 | | | | | | | | | |
| | N_PCItype | | | | | | | | | |
| N_PDU name | 7 | 6 | 5 | 4 | Bit 3-0 | Byte 2 | Byte 3 | Byte 4 | Byte 5 | Byte 6 |
| Single Frame | 0 | 0 | 0 | 0 | SF_DL | DATA 1 | DATA 2 | . . . | . . . | . . . |
| (CAN_DL ≤ 8) ^{(c)} | | | | | | | | | | |
| Single Frame | 0 | 0 | 0 | 0 | 0000 | SF_DL | DATA 1 | DATA 2 | . . . | . . . |
| (CAN_DL > 8) ^{(a)} | | | | | | | | | | |
| First Frame | 0 | 0 | 0 | 1 | FF_DL | | DATA 1 | DATA 2 | . . . | . . . |
| (FF_DL ≤ 4095) ^{(d)} | | | | | | | | | | |
| First Frame | 0 | 0 | 0 | 1 | 0000 | 00 | FF_DL | | | |
| (FF) | | | | | | | | | | |
| (FF_DL > 4095) ^{(b)} | | | | | | | | | | |
| Consecutive | 0 | 0 | 1 | 0 | SN | DATA 1 | DATA 2 | . . . | . . . | . . . |
| Frame | | | | | | | | | | |
| Flow Control | 0 | 0 | 1 | 1 | FS | BS | STmin | N/A | N/A | N/A |

Referring to Table 2 above, in the CAN-FD TP, for a single frame, it is classified that CAN_DL is less than or equal to 8 (c) and that CAN_DL is greater than 8 (a). It is classified that total data of the first frame are less than or equal to 4095 (d) and that the total data of the first frame are greater than 4095 (b). The consecutive frame and the flow control may be used in the same manner as the CAN TP. Thus, when total bytes of the CAN-FD message are greater than 8 bytes, a length thereof may be extended using format (a) and the first frame may be extended using format (b). Herein, basic flow between a transmission controller and a reception controller may operate in the same manner as the CAN.

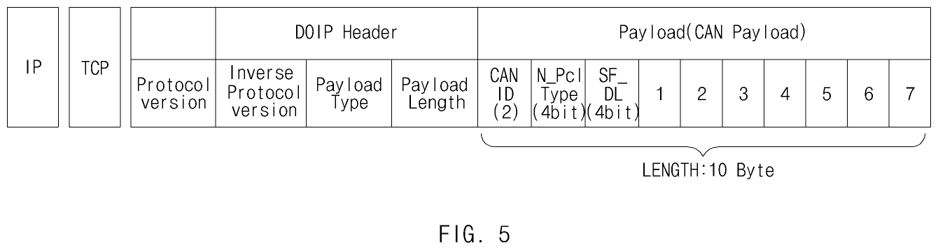

FIG. 5 is a drawing illustrating a message configuration for a CAN TP when configuring a CAN-FD message according to an embodiment of the present disclosure.

Referring to FIG. 5, when a diagnostic message is transmitted from an external controller (a transmitter), an internal controller may transmit internal vehicle data with regard to a CAN TP structure in the form of Table 3 below. In other words, the internal controller according to an embodiment of the present disclosure may have a frame structure of the CAN-FD, but may set the data length code (DLC) to 8 to configure the CAN-FD TP structure to be the same as the CAN TP structure. As a result, the internal controller may configure a message such that it is possible to perform protocol conversion from the CAN-FD to the CAN in an external contact point controller such as a gateway.

TABLE 3

| | N_PCI bytes | | | | | | | | | |
|---|---|---|---|---|---|---|---|---|---|---|
| | Byte 1 | | | | | | | | | |
| | N_PCItype | | | | | | | | | |
| N_PDU name | 7 | 6 | 5 | 4 | Bit 3-0 | Byte 2 | Byte 3 | Byte 4 | Byte 5 | Byte 6 |
| Single Frame | 0 | 0 | 0 | 0 | SF_DL | DATA 1 | DATA 2 | . . . | . . . | . . . |
| (CAN_DL ≤ 8) | | | | | | | | | | |

| | | | | | | | | | |
|---|---|---|---|---|---|---|---|---|---|
| First Frame | 0 | 0 | 0 | 1 | FF_DL | DATA 1 | DATA 2 | . . . | . . . |
| (FF_DL ≤ 4095) | | | | | | | | | |
| Consecutive | 0 | 0 | 1 | 0 | SN | DATA 1 | DATA 2 | . . . | . . . |
| Frame | | | | | | | | | |
| Flow Control | 0 | 0 | 1 | 1 | FS | BS | STmin | N/A | N/A |

As described above, the internal controller according to an embodiment of the present disclosure may set CAN_LD to 8 to use the same TP structure when transmitting internal data according to a diagnosis request of the external controller and may then control a frame to transmit the FF. Because of satisfying a first frame condition although there is FF_DL less than FF_DLmin (63) when CAN_DL is 8, the internal controller may configure CAN_DL of 8 where FF_DL is less than 63 as the first frame. Thus, the internal controller may control to receive CAN-FD data maintaining an 8-byte format according to a standard specification at an external CAN diagnostic device (a transmitter).

Meanwhile, when FF_DL is less than 8, error processing may be performed. In this case, even if it is the CAN protocol, it should be the single frame. Furthermore, although the DLC has the CAN-FD structure, when the DLC is greater than 8 and has PCI information such as Table 3 above, as it is impossible to perform gateway conversion, the external CAN diagnostic device may pop up an error as it is impossible to analyze a corresponding message.

In addition, although a general control message has the CAN-FD structure in Table 4 below as it does not perform external routing, it may be used without diagnosis communication or changing external diagnostic equipment. In other words, a data rate and a date size, which are advantages of the CAN-FD, may be maximally ensured.

TABLE 4

| | N_PCI bytes | | | | | | | | | |
|---|---|---|---|---|---|---|---|---|---|---|
| | Byte 1 | | | | | | | | | |
| | N_PCItype | | | | | | | | | |
| N_PDU name | 7 | 6 | 5 | 4 | Bit 3-0 | Byte 2 | Byte 3 | Byte 4 | Byte 5 | Byte 6 |
| Single Frame | 0 | 0 | 0 | 0 | 0000 | SF_DL | DATA 1 | DATA 2 | . . . | . . . |
| (CAN_DL > 8) | | | | | | | | | | |

| | | | | | | | |
|---|---|---|---|---|---|---|---|
| First Frame (FF) | 0 | 0 | 0 | 1 | 0000 | 00 | FF_DL |
| (FF_DL > 4095) | | | | | | | |

| | | | | | | | | | |
|---|---|---|---|---|---|---|---|---|---|
| Consecutive | 0 | 0 | 1 | 0 | SN | DATA 1 | DATA 2 | . . . | . . . |
| Frame | | | | | | | | | |
| Flow Control | 0 | 0 | 1 | 1 | FS | BS | STmin | N/A | N/A |

Most data or a diagnostic trouble code (DTC) to which the internal controller of the vehicle system responds may be very small in size and may be, for example, tens of bytes, Controller reprogramming, which occurs in the development stage, may be directly connected to a controller without passing through a gateway via a temporary connector to be used. Thereafter, the reprogramming may be deleted in stage M of the vehicle.

Thus, according to an example of the present disclosure, when using the CAN-FD TP structure such as Table 4 above, because the external diagnostic device uses the CAN-FD protocol, it may transfer data to the internal controller at a CAN-FD setting speed up to a maximum of 64 bytes. For error processing, most data may be the same as each other, but may have only a difference in FF_DL. In an existing technology, for the first frame (FF) having FF_DL less than an FF_DL min value, it may be ignored and the flow control (FC) may fail to be transmitted. As an example, when CAN_DL is 64 bytes, a size of data capable of being included in a corresponding message may be 62 bytes. In this case, it is possible to transmit the corresponding message with the single frame up to 62 bytes, and a minimum size of the first frame may be 63 bytes. Herein, when FF_DL is 60 bytes, because the corresponding message is a message which should be transmitted with the single frame, a receive end may ignore the message and may fail to transmit flow control which is a next step.

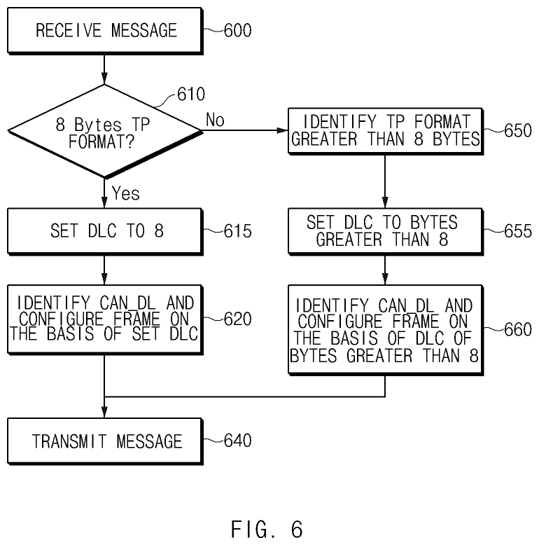

A description will be given of a flowchart illustrating an example where an internal controller configures a message through a CAN/CAN-FD TP duplex structure according to an embodiment of the present disclosure with reference to FIG. 6. Hereinafter, a description will be given in detail of a vehicle control method according to another embodiment of the present disclosure with reference to FIG. 6. Hereinafter, it is assumed that a vehicle controller 100 of FIG. 1 performs a process of FIG. 6. Furthermore, in a description of FIG. 6, an operation described as being performed by an apparatus may be understood as being controlled by a processor 140 of the vehicle controller 100.

Referring to FIG. 6, in S600, an internal controller may receive a message from an external controller. In this case, the received message may be a diagnosis request message by the external diagnostic device.

In S610, the internal controller may determine whether an identified TP structure of the received message has an 8-byte TP format. Alternatively, in S650, the internal controller may determine whether the TP structure has a TP format of bytes greater than 8 bytes.

When a format of the identified message is an 8-byte TP format, in S615, the internal controller may set the DLC of the control field of the CAN-FD data frame to 8. In this case, in S620, the internal controller may identify CAN_DL which is transmission data generated in the vehicle and may configure a frame on the basis of the set DLC of 8. In detail, the internal controller may compare CAN_DL on the basis of the set DLC of 8. Herein, the internal controller may compare CAN_DL to be transmitted with FF_DLmin (63) and may configure the identified CAN_DL as the first frame. In this case, when a size of the FF_DL is less than 8, the internal controller may configure the CAN_DL as the single frame.

Thereafter, the internal controller may transmit the configured data to an external diagnostic device through routing (an external contact point controller) using the CAN TP.

On the other hand, when the format of the identified message is a TP greater than 8 bytes, the internal controller may set the DLC of the control field of the CAN-FD data frame as one of DLCs shown in Table 1 above. As an example in the present disclosure, the description is given of setting the DLC to 64 bytes to improve a CAN-FD speed. However, as another example, the internal controller may set the DLC to one of 8, 12, 16, 20, 24, 32, 48, and 64 bytes depending on performance of a diagnostic device directly connected to the outside.

Thereafter, in S660, the internal controller may identify the CAN_DL which is data generated in the vehicle, depending on an external diagnosis request, and may configure a frame on the basis of a DLC of bytes greater than the set DLC of 8. In detail, the internal controller may compare CAN_DL with the CAN_DL which is the data generated in the vehicle on the basis of the set DLC, for example, 64. Herein, the internal controller may compare CAN_DL to be transmitted with FF_DLmin (63) and may configure the CAN_DL as the first frame. In this case, when a size of the FF_DL is less than 62, the internal controller may configure the CAN_DL as the single frame. Thereafter, in S640, the internal controller may directly transmit the configured frame to the external diagnostic device under the CAN-FD TP.

The vehicle controller, the internal controller, or the processor according to an embodiment of the present disclosure may configure data in the vehicle at a different TP size with regard to a TP structure of the external diagnostic device. The internal controller may configure the CAN TP of the standardized 8-byte format and the CAN-FD TP of the improved data format as a duplex structure to configure a message to be adaptive to the external diagnosis request.

According to an embodiment of the present disclosure, the present technology is applicable using only a procedure of simply correcting an ECU S/W TP structure, rather than replacing specific H/W such as a microcomputer or a memory. Thus, without increasing costs according to purchase or replacement of separate equipment, diagnosis may be performed.

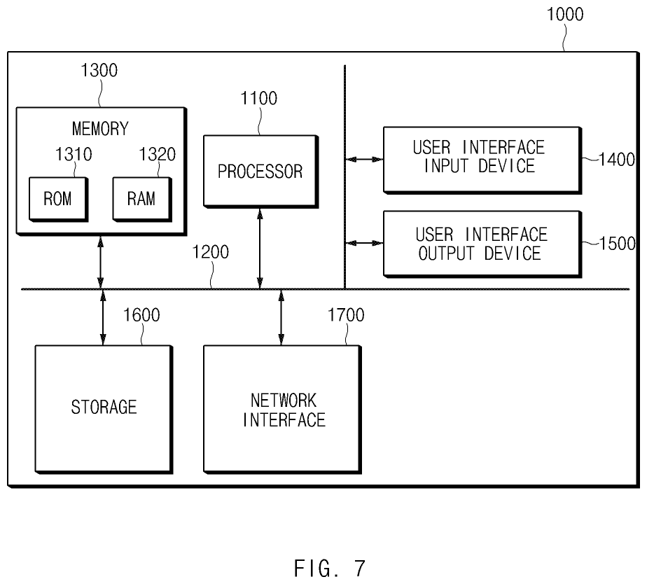

FIG. 7 is a block diagram illustrating a computing system according to an embodiment of the present disclosure.

Referring to FIG. 7, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) and a RAM (Random Access Memory).

Thus, the operations of the method or the algorithm described in connection with the embodiments disclosed herein may be embodied directly in hardware or a software module executed by the processor 1100, or in a combination thereof. The software module may reside on a storage medium (that is, the memory and/or the storage) such as a RAM, a flash memory, a ROM, an EPROM, an EEPROM, a register, a hard disk, a removable disk, and a CD-ROM.

The exemplary storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The present technology may transmit a TP of a fixed size to satisfy a standard specification by duplexing a CAN TP for transmission/reception and may maximally support a data rate and the amount of data, which are advantages of the CAN-FD, while maintaining compatibility with external diagnosis equipment. According to an embodiment of the present disclosure, the present technology may maintain compatibility with a legacy external diagnostic device by satisfying an external diagnostic specification (rules of North America) and may perform diagnosis at a faster speed than that in the classical CAN by performing data diagnosis at a CAN-FD speed and with the data amount of 64 bytes by using frequent reprogramming in the development as a temporary connector.

According to an embodiment of the present disclosure, the vehicle controller may not have a side-effect by conforming to an international standard specification for transmission/reception, may perform diagnostic communication according to each message structure, and may perform error processing. In addition, the present technology may maximally support a rate and the amount of data, which are advantages of the CAN-FD, on the basis of the reception of the updated controller by applying a recent over-the-air (OTA) technology or a technology of remotely updating controller S/W using wireless communication in each car OEM. Thus, the present technology may improve an OTA speed of the CAN-FD controller.

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. A vehicle controller, comprising:
a communication device configured to receive a diagnostic message for diagnosing a vehicle from an external diagnostic device; and
a processor configured to:
identify the diagnostic message; and
control the communication device to transmit data generated in the vehicle under a transport protocol (TP) selected between a first TP configuring data to a fixed size and a second TP configuring data to a variable size, the second TP being distinguished from the first TP.

2. The vehicle controller of claim 1, wherein the processor includes:
a first controller configured to control the first TP to transmit data with an 8-byte size; and
a second controller configured to control the second TP to transmit data with a byte size greater than the 8-byte size.

3. The vehicle controller of claim 1, wherein the processor is configured to:
form the first TP and the second TP in a duplex mode; and
transmits the data generated in the vehicle into a frame of an adaptive size depending on the diagnostic message.

4. The vehicle controller of claim 1, wherein the processor is configured to:
set a data length code (DLC) for the first TP to 8 bytes.

5. The vehicle controller of claim 4, wherein the processor is configured to:
compare the DLC set to 8 bytes with the data generated in the vehicle; and
form a controller area network (CAN) TP data frame of an 8-byte size.

6. The vehicle controller of claim 1, wherein the processor is configured to:
set a DLC for the second TP to 64 bytes.

7. The vehicle controller of claim 6, wherein the processor is configured to:
compare the DLC set to 64 bytes with the data generated in the vehicle; and
form a controller area network with flexible data rate (CAN-FD) TP data frame of an 64-byte size.

8. The vehicle controller of claim 1, wherein the processor is configured to:
set a DLC for the second TP to at least one of 8, 12, 16, 20, 24, 32, or 48 bytes.

9. The vehicle controller of claim 5, wherein the processor is configured to:
compare the DLC set to 8 bytes with the data generated in the vehicle to form a single frame; and
compare the DLC set to 8 bytes with a predetermined minimum value to form a first frame.

10. The vehicle controller of claim 9, wherein the processor is configured to:
set the predetermined minimum value to 63.

11. A vehicle control method, comprising:
receiving a diagnostic message to diagnose a vehicle from an external diagnostic device;
identifying the received diagnostic message; and
transmitting data generated in the vehicle under a transport protocol (TP) selected between a first TP configuring data to a fixed size and a second TP configuring data to a variable size, the second TP being distinguished from the first TP.

12. The vehicle control method of claim 11, wherein the transmitting of the data includes:
controlling the first TP to transmit data with an 8-byte size; and
controlling the second TP to transmit data with a byte size greater than the 8-byte size.

13. The vehicle control method of claim 11, wherein the transmitting of the data includes:
forming the first TP and the second TP in a duplex mode; and
transmitting the data generated in the vehicle into a frame of an adaptive size depending on the diagnostic message.

14. The vehicle control method of claim 11, wherein the transmitting of the data includes:
setting a data length code (DLC) for the first TP to 8 bytes.

15. The vehicle control method of claim 11, wherein the transmitting of the data includes:
comparing a DLC set to 8 bytes with the data generated in the vehicle; and
forming a CAN TP data frame of an 8-byte size.

16. The vehicle control method of claim 11, wherein the transmitting of the data includes:
setting a DLC for the second TP to 64 bytes.

17. The vehicle control method of claim 16, wherein the transmitting of the data includes:
comparing the DLC set to 64 bytes with the data generated in the vehicle; and
forming a CAN-FD TP data frame of a 64-byte size.

18. The vehicle control method of claim 11, wherein the transmitting of the data further includes:
setting a DLC for the second TP to at least one of 8, 12, 16, 20, 24, 32, or 48 bytes.

19. The vehicle control method of claim 11, wherein the transmitting of the data includes:
comparing a DLC set to 8 bytes with the data generated in the vehicle to form a single frame; and
comparing the DLC set to 8 bytes with a predetermined minimum value to form a first frame.

20. The vehicle control method of claim 19, wherein the transmitting of the data includes:
setting the predetermined minimum value to 63.
